(19) United States
(12) Patent Application Publication
(10) Pub. No.: US 2019/0394834 A1
(43) Pub. Date: Dec. 26, 2019

(54) MEASUREMENT GAP SHARING

(71) Applicant: Intel Corporation, Santa Clara, CA (US)

(72) Inventors: Jie Cui, Santa Clara, CA (US); Yang Tang, Santa Clara, CA (US); Rui Huang, Beijing (CN); Hua Li, Beijing (CN); Yuhan Zhou, Santa Clara, CA (US)

(21) Appl. No.: 16/408,377

(22) Filed: May 9, 2019

Related U.S. Application Data
(63) Continuation of application No. 16/277,928, filed on Feb. 15, 2019.
(60) Provisional application No. 62/710,321, filed on Feb. 16, 2018.

(51) Int. Cl. H04W 88/06; H04W 24/10; H04W 72/04; H04W 56/00

(52) U.S. Cl. CPC H04W 88/06; H04W 56/001; H04W 72/0453; H04W 24/10

(57) ABSTRACT

Embodiments of the present disclosure describe methods and apparatuses for measurement gap sharing.

### CROSS REFERENCE TO RELATED APPLICATIONS

This application is a continuation of U.S. patent application Ser. No. 16/277,928, filed Feb. 15, 2019, entitled “MEASUREMENT GAP SHARING,” which claims priority under 35 U.S.C. § 119(e) to U.S. Provisional Patent Application No. 62/710,321 entitled “MEASUREMENT GAP SHARING,” filed Feb. 16, 2018, the disclosures of which are incorporated herein by reference in their entireties.

### FIELD

Embodiments of the present disclosure generally relate to the field of networks, and more particularly, to apparatuses, systems, and methods for measurement gap sharing.

### BACKGROUND

A user equipment (UE) that is part of a cellular network periodically performs measurements in order to obtain network coverage. A measurement process may include, for example, a base station sending the UE a message to indicate items to measure, and the UE sending the base station a message in that indicates the results of the measurement.

In connection with a potential handover from one cellular network to another, for example, a UE measures the signal quality of its current cell, and the signal quality of a target cell. The UE then sends the base station a measurement report, so that a network is able to determine whether to perform a handover from the current cell to the target cell.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1A, 1B, and 1C illustrate three example scenarios according to some embodiments.

FIG. 2 illustrates an example apparatus for a UE according to some embodiments.

FIG. 3 illustrates an example operation flow/algorithmic structure of a UE according to some embodiments.

FIG. 4 illustrates an example architecture of a system of a network according to some embodiments.

FIG. 5 illustrates an example architecture of another system of a network according to some embodiments.

FIG. 6 illustrates example components of a device according to some embodiments.

FIG. 7 illustrates an example block diagram illustrating components according to some example embodiments.

FIG. 8 illustrates an exemplary communication circuitry according to some embodiments.

FIG. 9 illustrates an exemplary radio frequency circuitry according to some embodiments.

FIG. 10 illustrates an exemplary control plane protocol stack according to some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., in order to provide a thorough understanding of the various aspects of the claimed embodiments. However, it will be apparent to those skilled in the art having the benefit of the present disclosure that the various aspects of the embodiments claimed may be practiced in other examples that depart from these specific details. In certain instances, descriptions of well-known devices, circuits, and methods are omitted so as not to obscure the description of embodiments of the present disclosure with unnecessary detail.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in various embodiments,” “in some embodiments,” and the like are used repeatedly. The phrase generally does not refer to the same embodiments; however, it may. The terms “comprising,” “having,” and “including” are synonymous, unless the context dictates otherwise. The phrase “A or B” means (A), (B), or (A and B).

The term “coupled with,” along with its derivatives, may be used herein. “Coupled” may mean one or more of the following. “Coupled” may mean that two or more elements are in direct physical or electrical or communicative contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

The term “based on,” and the like, along with its derivatives, may be used herein. “Based on” may mean that one element is based entirely on another element, or “based on” may mean that one element is based at least in part on another element and thus may be based at least in part on other elements.

Example embodiments may be described as a process depicted as a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional operations not included in the figure(s). A process may correspond to a method, a function, a procedure, a subroutine, a subprogram, and the like. When a process corresponds to a function, its termination may correspond to a return of the function to the calling function and/or the main function.

As used herein, the term “processor circuitry” refers to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. As used herein, the term “interface circuitry” refers to, is part of, or includes circuitry providing for the exchange of information between two or more components or devices. The term “interface circuitry” may refer to one or more hardware interfaces (for example, buses, input/output (I/O) interfaces, peripheral component interfaces, and the like).

As used herein, the term “user equipment” or “UE” may be considered synonymous to, and may hereafter be occasionally referred to, as a client, mobile, mobile device, mobile terminal, user terminal, mobile unit, mobile station, mobile user, subscriber, user, remote station, access agent, user agent, receiver, etc., and may describe a remote user of network resources in a communications network. Furthermore, the term “user equipment” or “UE” may include any type of wireless/wired device such as consumer electronics devices, cellular phones, smartphones, tablet personal computers, Internet of Things (“IoT”) devices, smart sensors, wearable computing devices, personal digital assistants (PDAs), desktop computers, and laptop computers, for example.

As used herein, the term “base station” may be considered synonymous to, and may hereafter be occasionally referred to, as access nodes (ANs), NodeBs, evolved NodeBs (eNBs), next Generation NodeBs (gNB), radio access node (RAN) nodes, and so forth, and may comprise ground stations (e.g., terrestrial access points) or satellite stations providing coverage within a geographic area (e.g., a cell). A base station may be a device that is consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3^{rd} Generation Partnership Project (“3GPP”) Long Term Evolution (LTE) protocol, a fifth generation (5G) protocol, which may be referred to as New Radio (NR), or a protocol that is consistent with other existing generations, generations in development or to be developed in the future (e.g., second generation (2G), sixth generation (6G), etc.), an NR protocol, and the like.

With regard to measurements a UE may make, the UE may perform intra-frequency measurements of a current cell, which may also be referred to herein as a serving cell, and a target cell, which may also be referred to herein as a neighbor cell, where both the current cell and target cell operate on the same carrier frequency. A UE may also perform inter-frequency measurements, where the target cell operates on a different carrier frequency than the serving cell. Accordingly, an intra-frequency measurement may include a UE performing measurements on signals received from one or more neighbor cells at a downlink carrier frequency that is the same as a downlink carrier frequency of the UE's serving cell. Further, an inter-frequency measurement may include a UE performing measurements on signals received from one or more neighbor cells at a downlink carrier frequency that is different from a downlink carrier frequency of the UE's serving cell.

In general, there may be no issue when a UE measures the signal of the target cell when the target cell is at the same frequency as the current cell. However, when the target cell is at a different frequency than the current cell, a measurement gap is used. A measurement gap, which may also be referred to herein as an MG, is a time period during which no transmission or reception occurs with the current cell, so that a UE is able to switch to the target cell, perform one or more measurements, and return to the current cell. Therefore, the measurement gap is provided to enable the UE to perform inter-frequency measurements. Accordingly, certain types of UEs may perform intra-frequency measurement without the use of a measurement gap, but may need to perform inter-frequency measurement during the measurement gap, because the UE is unable to receive a signal from the serving cell at one frequency and a signal from the target cell on a different frequency at the same time. In addition, time is required for the UE to switch frequencies from the serving cell to the target cell. It is noted, however, that other types of UEs may use a measurement gap to perform both intra-frequency and inter-frequency measurements.

During the measurement gap, a UE may perform measurements such as, for example, but not limited to, a reference signal received power (RSRP), reference signal received quality (RSRQ), or signal-to-interference and noise ratio (SINR) measurement. Also during the measurement gap, a UE may perform radio link monitoring (RLM) to track the condition of a radio link, so that necessary actions may be taken if a radio link failure (RLF) occurs. Therefore, the UE may receive signals from a plurality of cells during the measurement gap, measure the quality or power of one or more of those cells, and then send a measurement report to its serving cell to report the received quality or power for each cell measured. If, for example, the signal power of the signal received from a neighbor cell is greater than the signal power of a signal received from the serving cell by, for example, more than a threshold, then the serving cell may decide to perform a handover of the UE to the neighbor cell.

An interruption, like a measurement gap, is a time period during which no transmission or reception may occur between a UE and a serving cell. However, an interruption differs from a measurement gap in that a measurement gap may be configured by a network, while an interruption is not configured by a network. With a measurement gap, a network may provide a UE with, for example, the periodicity (i.e., the starting point and ending point), duration (i.e., how long it lasts), and timing offset (i.e., the absolute timing of when to start it) of the measurement gap. An interruption, however, may occur due to, for example, but not limited to, radio frequency (RF) tuning/adjustment, mixed numerology, or beam sweeping.

To connect to a cell of a network, the UE may perform a set of operations known as a cell search. During the cell search, multiple synchronization stages may take place, during which the UE obtains time and frequency parameters that enable the UE to demodulate downlink signals and transmit uplink signals correctly. Two physical signals, a primary synchronization signal (PSS) and a secondary synchronization signal (SSS), may be broadcast in each cell in connection with synchronization. PSS and SSS synchronization are part of both intra-frequency and inter-frequency measurements performed by a UE. The period during which synchronization occurs may be referred to as a synchronization signal (SS)/physical broadcast channel (PBCH) block (SSB)-based measurement time configuration (SMTC) duration, which may also be referred to herein as an SMTC. An SMTC duration, like a measurement gap, may be configured by a network. For example, a network may provide a UE with, for example, the periodicity and duration of the SMTC duration.

Measurement types based on intra-frequency measurements and inter-frequency measurements include Type A, Type B, Type C, and Type D measurements. These measurement types may be defined for Frequency Range 1 (FR1), which may be defined by 3GPP as a frequency range, which may also be referred to as an operating range, from 450 megahertz (MHz) to 6000 MHz, and for Frequency Range 2 (FR2), which may be defined by 3GPP as a frequency range from 24,250 MHz to 52,600 MHz. Further, a measurement gap may be a per-FR1 measurement gap, where the same measurement gap is used for all frequencies or frequency layers within FR1. Similarly, a measurement gap may be a per-FR2 measurement gap, where the same measurement gap is used for all frequencies or frequency layers within FR2. In addition, a measurement gap may be a per-UE measurement gap, where a UE uses the same measurement gap for all frequencies or regardless of the frequency. Although embodiments herein may be described in terms of the above-referenced frequency ranges for FR1 and FR2, embodiments herein are applicable to other frequency ranges that 3GPP may define for FR1 and FR2.

A Type A measurement may be described as an intra-frequency measurement without RF tuning/adjustment, where the UE does not switch frequencies in order to, for example, but not limited to, conduct a measurement. For a Type A measurement, no measurement gap or interruption is needed. For FR1, a measurement may be considered as Type A: intra-frequency measurement without RF tuning/adjustment. Here, the baseline capability of a UE may be under consideration. Accordingly, a Type A measurement is an FR1 intra-frequency measurement without mixed numerology. For FR2, an interruption from beam sweeping is considered. It is thus noted that in FR2, there is no Type A measurement, given that a UE may do beam sweeping in FR2, which may cause an interruption, and a Type A measurement is a measurement with no interruption. Consequently, a network may only disable some MGs for RLM.

A Type B measurement may be described as an intra-frequency measurement with an interruption. The interruption here may be due to mixed numerologies in FR1 or beam sweeping in FR2. A Type C measurement may be described as an intra-frequency measurement with a measurement gap. A Type D measurement may be described as an inter-frequency measurement.

A Type A measurement (intra-frequency measurement without RF tuning) may overlap with a measurement gap, and a UE may not able to perform the intra-frequency measurement within the measurement gap. Thus, embodiments herein may include, for example, a measurement gap sharing mechanism so that all types of measurements have opportunities to be conducted.

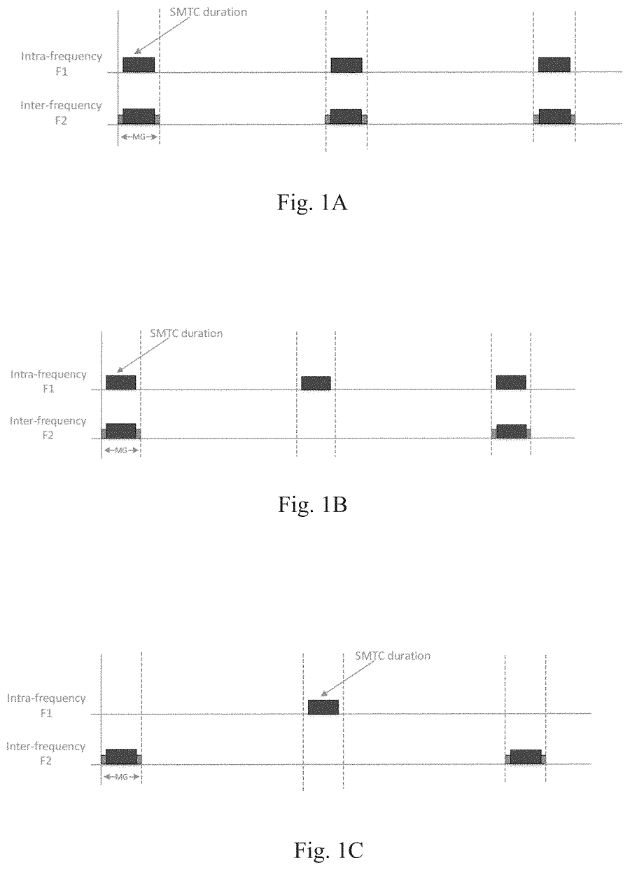

FIGS. 1A, 1B, and 1C illustrate three example scenarios according to some embodiments. Embodiments herein may involve the following three example scenarios. FIG. 1A illustrates a first scenario, where a measurement gap fully overlaps with an intra-frequency SMTC duration. FIG. 1B illustrates a second scenario, where a measurement gap partially overlaps with an intra-frequency SMTC duration. FIG. 1C illustrates a third scenario, where a measurement gap does not overlap with an intra-frequency SMTC duration. In an embodiment, a UE may be operating on a first frequency (F1) and, as described above, use the measurement gap to conduct a measurement on a second frequency (F2). In embodiments herein, the SMTC duration for F1 may be the same as the SMTC for F2. Further, in embodiments herein the SMTC duration for F1 may be different than the SMTC duration for F2.

In the first scenario, which may be referred to herein as Scenario 1, a measurement gap is fully overlapped with an intra-frequency SMTC duration. Since a Type B measurement (intra-frequency measurement with interruption) may introduce an interruption to the serving cell's data reception/transmission, a UE may use the measurement gap to conduct the Type B measurement directly, and the Type B measurement will share the gap resource with Type C and Type D measurements.

However, a Type A measurement may not be conducted during the measurement gap if the UE RF is tuned to another frequency layer. RLM may also be conducted during those Type A measurement occasions, which is important for a serving cell. Therefore, in order to, for example, provide the opportunities for Type A measurement and RLM, some MGs may be reserved, and the UE may not need to tune RF during those MGs. It may be unclear which MGs are reserved for Type A measurements and RLM. There may be, for example, the following two alternatives.

In a first alternative, which may be referred to as Alternative 1, a Type A measurement and RLM may also share the measurement gap with the other measurement types. With measurement gap sharing, the UE may control to conduct the Type A measurement, but network may not know which measurement gaps are disabled for Type A measurement and RLM, and thus the network may not be able to schedule the UE during those disabled measurement gaps.

In a second alternative, which may be referred to as Alternative 2, a network may indicate which measurement gaps are disabled for Type A measurement and RLM. A network may indicate a bitmap to disable some of the measurement gaps, and a UE may conduct the Type A measurement and RLM within those disabled measurement gaps. In addition, the network may schedule a UE within those disabled measurement gaps. Thus, Alternative 2 may benefit the data throughput from the UE and network perspectives.

Alternative 2 may be more beneficial because, for example, it may provide full measurement gap usage control to a network, though embodiments herein are not limited to Alternative 2. With Alternative 2, a network may indicate a bitmap to disable some of the measurement gaps for Type A measurement, and the rest of MGs will be shared by Type B, C, and D measurements.

In the second scenario, which may be referred to herein as Scenario 2, a MG is partially overlapped with intra-frequency SMTC duration. For a Type B measurement, since it will introduce an interruption to the serving data reception/transmission, it may be beneficial to conduct this measurement within the MG rather than outside the MG. Thus, the Type B measurement shares the measurement gap with Type C and D measurements. A Type A measurement may use the SMTC duration outside the MG to conduct the measurement and RLM; however, it may be beneficial for the network to control the measurement gap usage, i.e., the network may also indicate a bitmap to disable some of the measurement gaps for a Type A measurement and RLM, and the network may schedule data within those disabled measurement gaps to boost the throughput. Thus, Type B, C, and D measurements may share the rest of MGs which are not disabled by network.

In the third scenario, which may be referred to herein as Scenario 3, a MG is completely non-overlapped with intra-frequency SMTC duration, a Type B measurement may introduce an interruption to the serving data reception/transmission. If MGs are configured and no Type B measurement is covered by a MG, it will cause much data loss due to MG and interruption of UE measurement behaviors. Thus, a UE may not be allowed to conduct the Type B measurement outside the MG in this scenario. Although it may be a less beneficial configuration from a network that all of the Type B measurements are not covered by MGs, embodiments herein may include aspects for this configuration. Further, for a Type A measurement, since no MG is overlapped with SMTC duration for a Type A measurement, a UE may conduct those measurements on all the SMTC durations, outside of the measurement gap, and also conduct RLM outside of the measurement gap, which may be an additional benefit of embodiments herein so that all measurements have an opportunity to be conducted.

Based on the foregoing, Table 1 below summarizes a UE's behavior relative to the criteria used to apply measurement gap sharing. Measurement gap sharing involves the sharing of a measurement gap for use with different types of measurements. Accordingly, the criteria used to apply measurement gap sharing may include the following provided in Table 1 below. As used herein or in Table 1 below, a reference to “gaps,” “measurement gaps,” or “MGs” does not refer to more than one measurement gap, but instead refers to more than one occurrence of the same measurement gap.

TABLE 1

| Measurement Types | Scenario 1 | Scenario 2 | Scenario 3 |
|---|---|---|---|
| Type A measurement | Network indicate to | The SMTC outside | The SMTC outside |
| and RLM | disable some of the | MGs are used for | MGs are used for |
| Note: In FR2, there is | MGs for Type A | Type A measurements | Type A measurements |
| no Type A | measurement and | and RLM. | and RLM. |
| measurement, so a | RLM | Network may also | |
| network may only | | indicate to disable | |
| disable some of MGs | | some of the MGs for | |
| for RLM. | | Type A measurement | |
| | | and RLM. | |
| Type B measurement | The rest of MGs | The rest of MGs | Not allowed |
| Type C measurement | (which are not | (which are not | MGs are shared |
| Type D measurement | disabled by network) | disabled by network) | between Type C and D |
| | are shared by Type B, | are shared by Type B, | measurements. |
| | C, D measurements. | C, D measurements. | |

In an embodiment, a network may disable some of the measurement gaps for a Type A measurement and RLM in Scenarios 1 and 2.

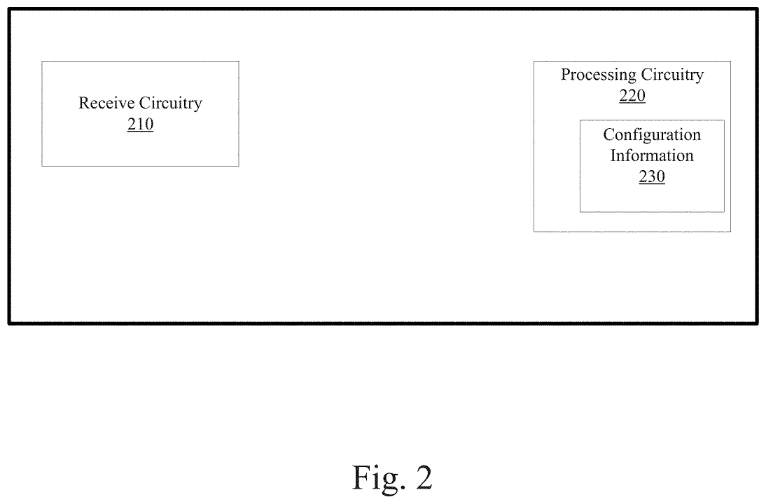

FIG. 2 illustrates an apparatus 200 that may be implemented as, or in, a UE according to some embodiments. In an embodiment, apparatus 200 may include memory 210, to store configuration information to define a measurement gap. In an embodiment, the configuration information to define the measurement gap may be received from a network. Apparatus 200 may further include processing circuitry 220, coupled with the memory, to measure, based on the measurement gap, a first cell on an intra-frequency carrier and a second cell on an inter-frequency carrier, where the measurement gap is shared for each measurement. In an embodiment, the measurement gap is a per-FR1 measurement gap, where FR1 is within the frequency range described above with regard to FR1. In an embodiment, the intra-frequency carrier is an FR1 intra-frequency carrier, and the inter-frequency carrier is an FR1 inter-frequency carrier. In another embodiment, the measurement gap is a per-FR2 measurement gap, wherein FR2 is within an frequency range described above with regard to FR2. In an embodiment, the intra-frequency carrier is an FR2 intra-frequency carrier, and the inter-frequency carrier is an FR2 inter-frequency carrier. In an embodiment, the first cell and the second cell are target cells.

In another embodiment, apparatus 200 may include memory 210 to store configuration information to define a measurement gap and to define an SMTC duration, and may further include processing circuitry 220, coupled with the memory 210, to conduct, based on a measurement type and an overlap of the measurement gap and the SMTC duration, one or more measurement types. In this embodiment, the configuration information to define the measurement gap and to define the SMTC may be received from a network. In this embodiment, the measurement type may be an intra-frequency measurement without RF tuning, and the measurement gap may overlap at least in part with the SMTC duration, where the measurement gap may overlap fully with the SMTC duration, as described above in connection with FIG. 1A, or may overlap partially with the SMTC duration, as described above in connection with FIG. 1B. Further, in this embodiment, the apparatus 200 may further receive from a network an indication to disable the measurement gap to conduct the measurement type, and the processing circuitry may disable, based on the indication to disable the measurement gap, the measurement gap to conduct the measurement type. Further, in this embodiment, the processing circuitry may use a portion of the SMTC duration outside of the measurement gap to conduct the measurement type.

Further, in this embodiment, the measurement type may be an inter-frequency measurement, and the measurement gap and the SMTC duration may not overlap, where no overlap exists between the measurement gap and the SMTC duration. In this embodiment, the processing circuitry is may further use a portion of the SMTC duration outside of the measurement gap to conduct a measurement type.

Further, in this embodiment, a first measurement type may be an intra-frequency measurement with the measurement gap, and a second measurement type is an inter-frequency measurement. In this embodiment, the measurement gap may overlap at least in part with the SMTC duration, and the processing circuitry may further use the measurement gap to conduct the first measurement type and the second measurement type, where another measurement gap is disabled by a network. In this embodiment, a third measurement type may be an intra-frequency measurement with an interruption, and the processing circuitry may further use the measurement gap to conduct the third measurement type. In addition, in this embodiment, the measurement gap and the SMTC duration may not overlap, and the processing circuitry may further to use the measurement gap to conduct the first measurement type and the second measurement type.

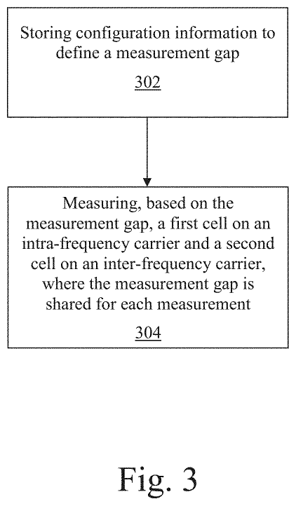

FIG. 3 illustrates an example operation flow/algorithmic structure of a UE according to some embodiments. In some embodiments, some or all of operation flow/algorithmic structure 300 may be practiced by components shown or described with respect to apparatus 200. Operation flow/algorithmic structure 300 may include, at 302, storing configuration information to define a measurement gap. Operation flow/algorithmic structure 300 may include, at 304, measuring, based on the measurement gap, a first cell on an intra-frequency carrier and a second cell on an inter-frequency carrier, where the measurement gap is shared for each measurement. In an embodiment, the measurement gap is a per-FR 1 measurement gap, where FR1 is within the frequency range described above with regard to FR1. In an embodiment, the intra-frequency carrier is an FR1 intra-frequency carrier, and the inter-frequency carrier is an FR1 inter-frequency carrier. In another embodiment, the measurement gap is a per-FR2 measurement gap, wherein FR2 is within the frequency range described above with regard to FR2. In an embodiment, the intra-frequency carrier is an FR2 intra-frequency carrier, and the inter-frequency carrier is an FR2 inter-frequency carrier.

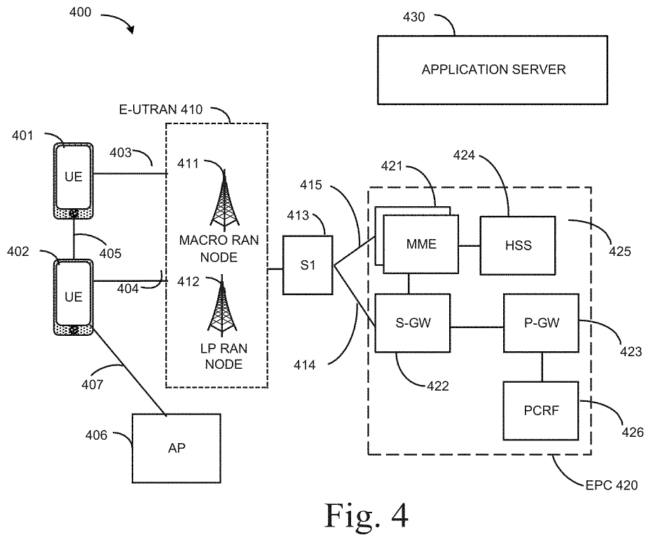

FIG. 4 illustrates an example architecture of a system 400 of a network according to some embodiments. The system 400 is shown to include a user equipment (UE) 401 and a UE 402. UE 401 or UE 402 may, for example, perform operation flow/algorithmic processes 300, or may, for example, be the same or similar to, or additionally or alternatively, include the components of, apparatus 200 discussed previously. The UEs 401 and 402 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, vehicles, or any computing device including a wireless communications interface.

In some embodiments, any of the UEs 401 and 402 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 401 and 402 may be configured to connect, e.g., communicatively couple, with a radio access network (RAN)—in this embodiment, an Evolved Universal Mobile Telecommunications System (UMTS) Terrestrial Radio Access Network (E-UTRAN) 410. The UEs 401 and 402 utilize connections 403 and 404, respectively, each of which comprises a physical communications interface or layer (discussed in further detail below); in this example, the connections 403 and 404 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 401 and 402 may further directly exchange communication data via a ProSe interface 405. The ProSe interface 405 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 402 is shown to be configured to access an access point 406 via connection 407. The connection 407 can comprise a local wireless connection, such as a connection consistent with any IEEE 802.11 protocol, wherein the access point 406 would comprise a wireless fidelity (WiFi®) router. In this example, the access point 406 is shown to be connected to the Internet without connecting to the core network of the wireless system (described in further detail below).

The E-UTRAN 410 can include one or more access nodes that enable the connections 403 and 404. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 410 may include one or more RAN nodes for providing macrocells, e.g., macro RAN node 411, and one or more RAN nodes for providing femtocells or picocells (e.g., cells having smaller coverage areas, smaller user capacity, or higher bandwidth compared to macrocells), e.g., low power (LP) RAN node 412.

Any of the RAN nodes 411 and 412 can terminate the air interface protocol and can be the first point of contact for the UEs 401 and 402. In some embodiments, any of the RAN nodes 411 and 412 can fulfill various logical functions for the E-UTRAN 410 including, but not limited to, radio network controller (RNC) functions such as radio bearer management, uplink and downlink dynamic radio resource management and data packet scheduling, and mobility management.

In accordance with some embodiments, the UEs 401 and 402 can be configured to communicate using Orthogonal Frequency-Division Multiplexing (OFDM) communication signals with each other or with any of the RAN nodes 411 and 412 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 411 and 412 to the UEs 401 and 402, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 401 and 402. The physical downlink control channel (PDCCH) may carry information about the transport format and resource allocations related to the PDSCH channel, among other things. It may also inform the UEs 401 and 402 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 411 and 412 based on channel quality information fed back from any of the UEs 401 and 402. The downlink resource assignment information may be sent on the PDCCH used for (e.g., assigned to) each of the UEs 401 and 402.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The E-UTRAN 410 is shown to be communicatively coupled to a core network—in this embodiment, an Evolved Packet Core (EPC) network 420 via an S1 interface 413. In this embodiment the S1 interface 413 is split into two parts: the S1-U interface 414, which carries traffic data between the RAN nodes 411 and 412 and the serving gateway (S-GW) 422, and the S1-mobility management entity (MME) interface 415, which is a signaling interface between the RAN nodes 411 and 412 and MMEs 421.

In this embodiment, the EPC network 420 comprises the MMEs 421, the S-GW 422, the Packet Data Network (PDN) Gateway (P-GW) 423, and a home subscriber server (HSS) 424. The MMEs 421 may be similar in function to the control plane of legacy Serving General Packet Radio Service (GPRS) Support Nodes (SGSN). The MMEs 421 may manage mobility aspects in access such as gateway selection and tracking area list management. The HSS 424 may comprise a database for network users, including subscription-related information to support the network entities' handling of communication sessions. The EPC network 420 may comprise one or several HSSs 424, depending on the number of mobile subscribers, on the capacity of the equipment, on the organization of the network, etc. For example, the HSS 424 can provide support for routing/roaming, authentication, authorization, naming/addressing resolution, location dependencies, etc.

The S-GW 422 may terminate the S1 interface 413 towards the E-UTRAN 410, and routes data packets between the E-UTRAN 410 and the EPC network 420. In addition, the S-GW 422 may be a local mobility anchor point for inter-RAN node handovers and also may provide an anchor for inter-3GPP mobility. Other responsibilities may include lawful intercept, charging, and some policy enforcement.

The P-GW 423 may terminate an SGi interface toward a PDN. The P-GW 423 may route data packets between the EPC network 423 and external networks such as a network including the application server 430 (alternatively referred to as application function (AF)) via an Internet Protocol (IP) interface 425. Generally, the application server 430 may be an element offering applications that use IP bearer resources with the core network (e.g., UMTS Packet Services (PS) domain, LTE PS data services, etc.). In this embodiment, the P-GW 423 is shown to be communicatively coupled to an application server 430 via an IP communications interface 425. The application server 430 can also be configured to support one or more communication services (e.g., Voice-over-Internet Protocol (VoIP) sessions, PTT sessions, group communication sessions, social networking services, etc.) for the UEs 401 and 402 via the EPC network 420.

The P-GW 423 may further be a node for policy enforcement and charging data collection. Policy and Charging Enforcement Function (PCRF) 426 is the policy and charging control element of the EPC network 420. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 426 may be communicatively coupled to the application server 430 via the P-GW 423. The application server 430 may signal the PCRF 426 to indicate a new service flow and select the appropriate Quality of Service (QoS) and charging parameters. The PCRF 426 may provision this rule into a Policy and Charging Enforcement Function (PCEF) (not shown) with the appropriate traffic flow template (TFT) and QoS class of identifier (QCI), which commences the QoS and charging as specified by the application server 430.

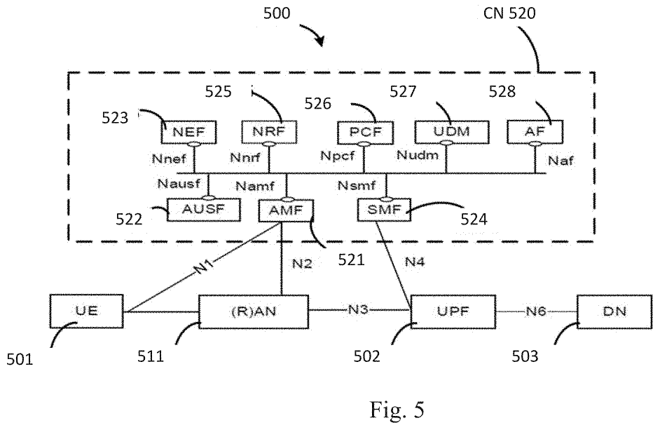

FIG. 5 illustrates an architecture of a system 500 of a network in accordance with some embodiments. The system 500 is shown to include a UE 501, which may be the same or similar to UEs 401 and 402 discussed previously; a RAN node 511, which may be the same or similar to RAN nodes 411 and 412 discussed previously; a User Plane Function (UPF) 502; a Data network (DN) 503, which may be, for example, operator services, Internet access or 3rd party services; and a 5G Core Network (5GC or CN) 520. UE 501 may, for example, perform operation flow/algorithmic process 300, or may, for example, be the same or similar to, or additionally or alternatively, include the components of, apparatus 200 discussed previously.

The CN 520 may include an Authentication Server Function (AUSF) 522; a Core Access and Mobility Management Function (AMF) 521; a Session Management Function (SMF) 524; a Network Exposure Function (NEF) 523; a Policy Control function (PCF) 526; a Network Function (NF) Repository Function (NRF) 525; a Unified Data Management (UDM) 527; and an Application Function (AF) 528. The CN 520 may also include other elements that are not shown, such as a Structured Data Storage network function (SDSF), an Unstructured Data Storage network function (UDSF), and the like.

The UPF 502 may act as an anchor point for intra-RAT and inter-RAT mobility, an external PDU session point of interconnect to DN 503, and a branching point to support multi-homed PDU session. The UPF 502 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF 502 may include an uplink classifier to support routing traffic flows to a data network. The DN 503 may represent various network operator services, Internet access, or third party services. NY 503 may include, or be similar to application server 430 discussed previously.

The AUSF 522 may store data for authentication of UE 501 and handle authentication related functionality. Further, the AUSF 522 may facilitate a common authentication framework for various access types.

The AMF 521 may be responsible for registration management (e.g., for registering UE 501, etc.), connection management, reachability management, mobility management, and lawful interception of AMF-related events, and access authentication and authorization. AMF 521 may provide transport for SM messages between and SMF 524, and act as a transparent proxy for routing SM messages. AMF 521 may also provide transport for short message service (SMS) messages between UE 501 and an SMS function (SMSF) (not shown by FIG. 5). AMF 521 may act as Security Anchor Function (SEA), which may include interaction with the AUSF 522 and the UE 501, receipt of an intermediate key that was established as a result of the UE 501 authentication process. Where USIM based authentication is used, the AMF 521 may retrieve the security material from the AUSF 522. AMF 521 may also include a Security Context Management (SCM) function, which receives a key from the SEA that it uses to derive access-network specific keys. Furthermore, AMF 521 may be a termination point of RAN CP interface (N2 reference point), a termination point of NAS (N1) signalling, and perform NAS ciphering and integrity protection.

AMF 521 may also support NAS signalling with a UE 501 over an N3 interworking-function (IWF) interface. The N3IWF may be used to provide access to untrusted entities. N33IWF may be a termination point for the N2 and N3 interfaces for control plane and user plane, respectively, and as such, may handle N2 signalling from SMF and AMF for PDU sessions and QoS, encapsulate/de-encapsulate packets for IPSec and N3 tunnelling, mark N3 user-plane packets in the uplink, and enforce QoS corresponding to N3 packet marking taking into account QoS requirements associated to such marking received over N2. N3IWF may also relay uplink and downlink control-plane NAS (N1) signalling between the UE 501 and AMF 521, and relay uplink and downlink user-plane packets between the UE 501 and UPF 502. The N3IWF also provides mechanisms for IPsec tunnel establishment with the UE 501.

The SMF 524 may be responsible for session management (e.g., session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. The SMF 524 may include the following roaming functionality: handle local enforcement to apply QoS SLAB (VPLMN); charging data collection and charging interface (VPLMN); lawful intercept (in VPLMN for SM events and interface to LI System); support for interaction with external DN for transport of signalling for PDU session authorization/authentication by external DN.

The NEF 523 may provide means for securely exposing the services and capabilities provided by 3GPP network functions for third party, internal exposure/re-exposure, Application Functions (e.g., AF 528), edge computing or fog computing systems, etc. In such embodiments, the NEF 523 may authenticate, authorize, and/or throttle the AFs. NEF 523 may also translate information exchanged with the AF 528 and information exchanged with internal network functions. For example, the NEF 523 may translate between an AF-Service-Identifier and an internal 5GC information. NEF 523 may also receive information from other network functions (NFs) based on exposed capabilities of other network functions. This information may be stored at the NEF 523 as structured data, or at a data storage NF using a standardized interfaces. The stored information can then be re-exposed by the NEF 523 to other NFs and AFs, and/or used for other purposes such as analytics.

The NRF 525 may support service discovery functions, receive NF Discovery Requests from NF instances, and provide the information of the discovered NF instances to the NF instances. NRF 525 also maintains information of available NF instances and their supported services.

The PCF 526 may provide policy rules to control plane function(s) to enforce them, and may also support unified policy framework to govern network behaviour. The PCF 526 may also implement a front end (FE) to access subscription information relevant for policy decisions in a UDR of UDM 527.

The UDM 527 may handle subscription-related information to support the network entities' handling of communication sessions, and may store subscription data of UE 501. The UDM 527 may include two parts, an application FE and a User Data Repository (UDR). The UDM may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with PCF 526. UDM 527 may also support SMS management, wherein an SMS-FE implements the similar application logic as discussed previously.

The AF 528 may provide application influence on traffic routing, access to the Network Capability Exposure (NCE), and interact with the policy framework for policy control. The NCE may be a mechanism that allows the 5GC and AF 528 to provide information to each other via NEF 523, which may be used for edge computing implementations. In such implementations, the network operator and third party services may be hosted close to the UE 501 access point of attachment to achieve an efficient service delivery through the reduced end-to-end latency and load on the transport network. For edge computing implementations, the 5GC may select a UPF 502 close to the UE 501 and execute traffic steering from the UPF 502 to DN 503 via the N6 interface. This may be based on the UE subscription data, UE location, and information provided by the AF 528. In this way, the AF 528 may influence UPF (re)selection and traffic routing. Based on operator deployment, when AF 528 is considered to be a trusted entity, the network operator may permit AF 528 to interact directly with relevant NFs.

As discussed previously, the CN 520 may include an SMSF, which may be responsible for SMS subscription checking and verification, and relaying SM messages to/from the UE 501 to/from other entities, such as an SMS-GMSC/IWMSC/SMS-router. The SMS may also interact with AMF 521 and UDM 527 for notification procedure that the UE 501 is available for SMS transfer (e.g., set a UE not reachable flag, and notifying UDM 527 when UE 501 is available for SMS).

The system 500 may include the following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

The system 500 may include the following reference points: N1: Reference point between the UE and the AMF; N2: Reference point between the (R)AN and the AMF; N3: Reference point between the (R)AN and the UPF; N4: Reference point between the SMF and the UPF; and N6: Reference point between the UPF and a Data Network. There may be many more reference points and/or service-based interfaces between the NF services in the NFs, however, these interfaces and reference points have been omitted for clarity. For example, an N5 reference point may be between the PCF and the AF; an N7 reference point may be between the PCF and the SMF; an N11 reference point between the AMF and SMF; etc. In some embodiments, the CN 520 may include an Nx interface, which is an inter-CN interface between the MME (e.g., MME 421) and the AMF 521 in order to enable interworking between CN 520 and EPC network 420.

Although not shown by FIG. 5, system 500 may include multiple RAN nodes 511 wherein an Xn interface is defined between two or more RAN nodes 511 (e.g., gNBs and the like) that connecting to 5GC 520, between a RAN node 511 (e.g., gNB) connecting to 5GC 520 and an eNB (e.g., a RAN node 411 of FIG. 4), and/or between two eNBs connecting to 5GC 520.

In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 501 in a connected mode (e.g., CM-CONNECTED) including functionality to manage the UE mobility for connected mode between one or more RAN nodes 511. The mobility support may include context transfer from an old (source) serving RAN node 511 to new (target) serving RAN node 511; and control of user plane tunnels between old (source) serving RAN node 511 to new (target) serving RAN node 511.

A protocol stack of the Xn-U may include a transport network layer built on Internet Protocol (IP) transport layer, and a GTP—U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer point-to-point transmission is used to deliver the signaling PDUs. In other implementations, the Xn-U protocol stack and/or the Xn-C protocol stack may be same or similar to the user plane and/or control plane protocol stack(s) shown and described herein.

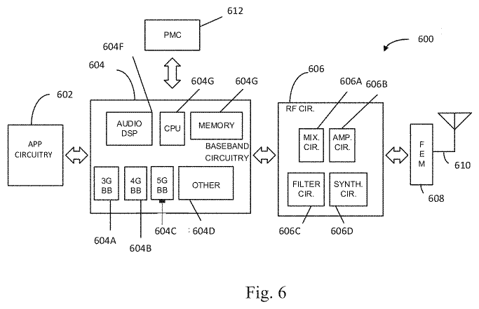

FIG. 6 illustrates example components of a device 600 in accordance with some embodiments. In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE, which may, for example, perform operation flow/algorithmic process 300, or may, for example, include the components of apparatus 200 discussed previously, or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), si11h generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a requirement. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

FIG. 6 shows the PMC 612 coupled only with the baseband circuitry 604. However, in other embodiments, the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in an RRC_Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

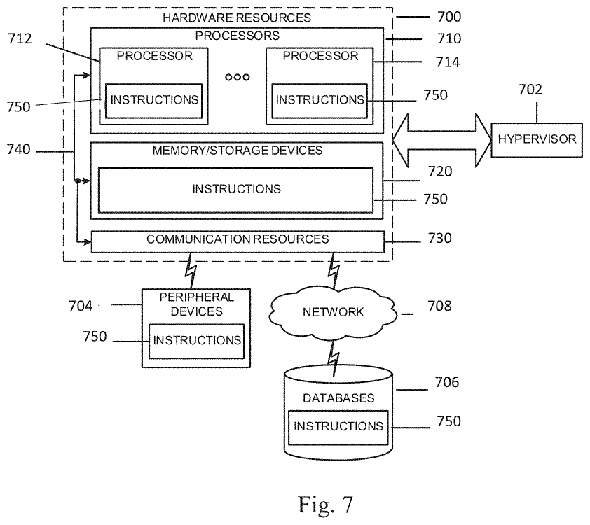

FIG. 7 is an example block diagram illustrating components according to some example embodiments, able to read instructions from a machine-readable or computer-readable medium (e.g., a non-transitory machine-readable storage medium) and perform any one or more of the methodologies discussed herein, such as, for example, but not limited to, operation flow/algorithmic structure 300. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 712 and a processor 714.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc. The memory/storage devices 720 may store data for operations by one or more processors that may execute the instructions of operation flow/algorithmic structure 700, where such data may include, for example, transmit diversity scheme information, which may include, for example, the identity and associated parameters of a transmit diversity scheme. Further, the memory/storage devices 720 may store data for operations by one or more processors that may execute the instructions of operation flow/algorithmic structure 800, where such data may include, for example, PDCCH DMRS information.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

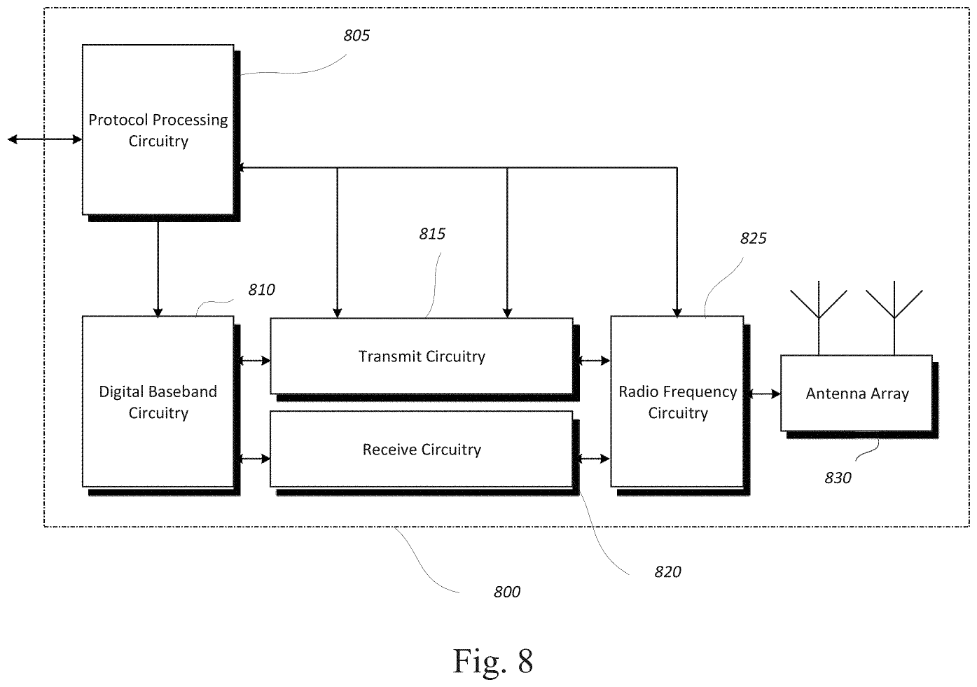

FIG. 8 illustrates an exemplary communication circuitry 800 according to some aspects. Circuitry 800 is alternatively grouped according to functions. Components as shown in circuitry 800 are shown here for illustrative purposes and may include other components not shown in FIG. 8. Circuitry 800 may, for example, be included in apparatus 200 discussed previously.

Communication circuitry 800 may include protocol processing circuitry 805, which may implement one or more of medium access control (MAC), radio link control (RLC), packet data convergence protocol (PDCP), radio resource control (RRC) and non-access stratum (NAS) functions. Protocol processing circuitry 805 may include one or more processing cores (not shown) to execute instructions and one or more memory structures (not shown) to store program and data information. Protocol processing circuitry 805 may, for example, perform operation flow/algorithmic process 300.

Communication circuitry 800 may further include digital baseband circuitry 810, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

Communication circuitry 800 may further include transmit circuitry 815, receive circuitry 820 and/or antenna array circuitry 830.

Communication circuitry 800 may further include radio frequency (RF) circuitry 825. In an aspect of the embodiments herein, RF circuitry 825 may include multiple parallel RF chains for one or more of transmit or receive functions, each connected to one or more antennas of the antenna array 830.

In an aspect of the disclosure, protocol processing circuitry 805 may include one or more instances of control circuitry (not shown) to provide control functions for one or more of digital baseband circuitry 810, transmit circuitry 815, receive circuitry 820, and/or radio frequency circuitry 825.

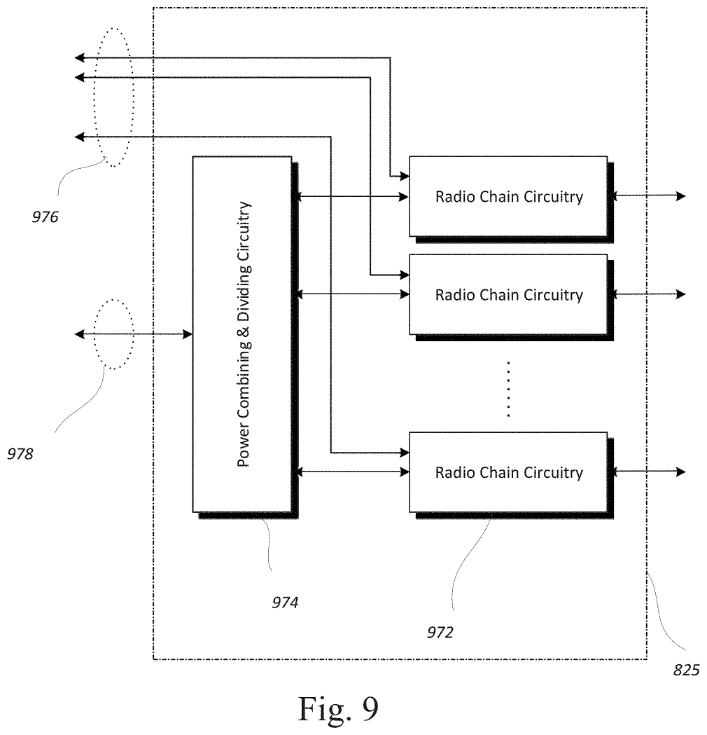

FIG. 9 illustrates an exemplary radio frequency circuitry 825 in FIG. 8 according to some aspects. Radio frequency circuitry 825 may include one or more instances of radio chain circuitry 972, which in some aspects may include one or more filters, power amplifiers, low noise amplifiers, programmable phase shifters and power supplies (not shown).

Radio frequency circuitry 825 may include power combining and dividing circuitry 974 in some aspects. In some aspects, power combining and dividing circuitry 974 may operate bidirectionally, such that the same physical circuitry may be configured to operate as a power divider when the device is transmitting, and as a power combiner when the device is receiving. In some aspects, power combining and dividing circuitry 974 may one or more include wholly or partially separate circuitries to perform power dividing when the device is transmitting and power combining when the device is receiving. In some aspects, power combining and dividing circuitry 974 may include passive circuitry comprising one or more two-way power divider/combiners arranged in a tree. In some aspects, power combining and dividing circuitry 974 may include active circuitry comprising amplifier circuits.

In some aspects, radio frequency circuitry 825 may connect to transmit circuitry 815 and receive circuitry 820 in FIG. 8 via one or more radio chain interfaces 976 or a combined radio chain interface 978.

In some aspects, one or more radio chain interfaces 976 may provide one or more interfaces to one or more receive or transmit signals, each associated with a single antenna structure which may comprise one or more antennas.

In some aspects, the combined radio chain interface 978 may provide a single interface to one or more receive or transmit signals, each associated with a group of antenna structures comprising one or more antennas.

In some embodiments, the combined radio chain interface 978 may be used for millimeter wave communications, while the one or more radio chain interfaces 976 may be used for lower-frequency communications.

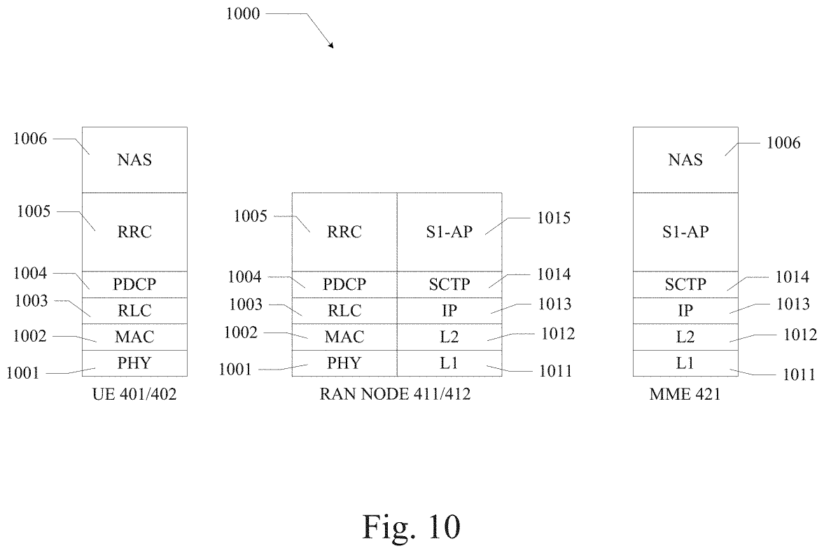

FIG. 10 is an exemplary control plane protocol stack in accordance with some embodiments. In this embodiment, a control plane 1000 is shown as a communications protocol stack between the UE 401 (or alternatively, the UE 402), the RAN node 411 (or alternatively, the RAN node 412), and the MME 421.

The PHY layer 1001 may transmit or receive information used by the MAC layer 1002 over one or more air interfaces. The PHY layer 1001 may further perform link adaptation or adaptive modulation and coding (AMC), power control, cell search (e.g., for initial synchronization and handover purposes), and other measurements used by higher layers, such as the RRC layer 1005. The PHY layer 1001 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1002 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1003 may operate in a plurality of modes of operation, including: Transparent Mode (TM), Unacknowledged Mode (UM), and Acknowledged Mode (AM). The RLC layer 1003 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1003 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1004 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1005 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 401 and the RAN node 411 may utilize a Uu interface (e.g., an LTE-Uu interface) to exchange control plane data via a protocol stack comprising the PHY layer 1001, the MAC layer 1002, the RLC layer 1003, the PDCP layer 1004, and the RRC layer 1005.

The non-access stratum (NAS) protocols 1006 form the highest stratum of the control plane between the UE 401 and the MME 421. The NAS protocols 1006 support the mobility of the UE 401 and the session management procedures to establish and maintain IP connectivity between the UE 401 and the P-GW 423.

The S1 Application Protocol (S1-AP) layer 1015 may support the functions of the S1 interface and comprise Elementary Procedures (EPs). An EP is a unit of interaction between the RAN node 411 and the CN 420. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1014 may ensure reliable delivery of signaling messages between the RAN node 411 and the MME 421 based, in part, on the IP protocol, supported by the IP layer 1013. The L2 layer 1012 and the L1 layer 1011 may refer to communication links (e.g., wired or wireless) used by the RAN node and the MME to exchange information.

The RAN node 411 and the MME 421 may utilize an S1-MME interface to exchange control plane data via a protocol stack comprising the L1 layer 1011, the L2 layer 1012, the IP layer 1013, the SCTP layer 1014, and the S1-AP layer 1015.

Some non-limiting examples are provided below.

### Examples

Example 1 may include an apparatus to be implemented in a user equipment (UE), the apparatus comprising: memory, to store configuration information to define a measurement gap; and processing circuitry, coupled with the memory, to: measure, based on the measurement gap, a first cell on an intra-frequency carrier and a second cell on an inter-frequency carrier, wherein the measurement gap is shared for each measurement.

Example 2 may include the apparatus of Example 1 or some other example herein, wherein the measurement gap is a per-Frequency Range 1 (FR1) measurement gap, wherein a FR1 is within a frequency range between 450 megahertz (MHz) and 6,000 MHz.

Example 3 may include the apparatus of Example 2 or some other example herein, wherein the intra-frequency carrier is an FR1 intra-frequency carrier, and wherein the inter-frequency carrier is an FR1 inter-frequency carrier.

Example 4 may include the apparatus of Example 1 or some other example herein, wherein the measurement gap is a per-Frequency Range 2 (FR2) measurement gap, wherein an FR2 is within a frequency range between 24,250 MHz and 52,600 MHz.

Example 5 may include the apparatus of Example 4 or some other example herein, wherein the intra-frequency carrier is an FR2 intra-frequency carrier, and wherein the inter-frequency carrier is an FR2 inter-frequency carrier.

Example 6 may include one or more non-transitory computer-readable media having instructions that, when executed by one or more processors, cause an apparatus of a user equipment (UE) to: store configuration information to define a measurement gap; and measure, based on the measurement gap, a first cell on an intra-frequency carrier and a second cell on an inter-frequency carrier, wherein the measurement gap is shared for each measurement.

Example 7 may include the one or more non-transitory computer-readable media of Example 6 or some other example herein, wherein the measurement gap is a per-Frequency Range 1 (FR1) measurement gap, wherein an FR1 is within an frequency range between 450 megahertz (MHz) and 6,000 MHz.

Example 8 may include the one or more non-transitory computer-readable media of Example 7 or some other example herein, wherein the intra-frequency carrier is an FR1 intra-frequency carrier, and wherein the inter-frequency carrier is an FR1 inter-frequency carrier.

Example 9 may include the one or more non-transitory computer-readable media of Example 6 or some other example herein, wherein the measurement gap is a per-Frequency Range 2 (FR2) measurement gap, wherein FR2 is within a frequency range between 24,250 MHz and 52,600 MHz.

Example 10 may include the one or more non-transitory computer-readable media of Example 9 or some other example herein, wherein the intra-frequency carrier is an FR2 intra-frequency carrier, and wherein the inter-frequency carrier is an FR2 inter-frequency carrier.

Example 11 may include an apparatus to be implemented in a user equipment (UE), comprising: memory, to store configuration information to define a measurement gap and to define an intra-frequency synchronization signal (SS)/physical broadcast channel (PBCH) block (SSB)-based measurement time configuration (SMTC) duration; and processing circuitry, coupled with the memory, to: conduct, based on a measurement type and an overlap of the measurement gap and the SMTC duration, one or more measurement types.

Example 12 may include the apparatus of Example 11 or some other example herein, wherein the measurement type is an intra-frequency measurement without radio frequency (RF) tuning, and wherein the measurement gap overlaps at least in part with the SMTC duration.

Example 13 may include the apparatus of Example 12 or some other example herein, wherein the apparatus is further to receive from a network an indication to disable the measurement gap to conduct the measurement type, and wherein the processing circuitry is further to disable, based on the indication to disable the measurement gap, the measurement gap to conduct the measurement type.

Example 14 may include the apparatus of Example 12 or some other example herein, wherein the processing circuitry is further to use a portion of the SMTC duration outside of the measurement gap to conduct a measurement type.

Example 15 may include the apparatus of Example 11 or some other example herein, wherein the measurement type is an inter-frequency measurement, and wherein the measurement gap and the SMTC duration do not overlap.

Example 16 may include the apparatus of Example 12 or some other example herein, wherein the processing circuitry is further to use a portion of the SMTC duration outside of the measurement gap to conduct a measurement type.

Example 17 may include the apparatus of Example 11 or some other example herein, wherein a first measurement type is an intra-frequency measurement with the measurement gap, and wherein a second measurement type is an inter-frequency measurement.

Example 18 may include the apparatus of Example 17 or some other example herein, wherein the measurement gap overlaps at least in part with the SMTC duration, wherein the processing circuitry is further to use the measurement gap to conduct the first measurement type and the second measurement type, and wherein another measurement gap is disabled by a network.

Example 19 may include the apparatus of Example 18 or some other example herein, wherein a third measurement type is an intra-frequency measurement with an interruption, and wherein the processing circuitry is further to use the measurement gap to conduct the third measurement type.

Example 20 may include the apparatus of Example 17 or some other example herein, wherein the measurement gap and the SMTC duration do not overlap, and wherein the processing circuitry is further to use the measurement gap to conduct the first measurement type and the second measurement type.

Example 21 may include a method, comprising: storing configuration information to define a measurement gap; and measuring, based on the measurement gap, a first cell on an intra-frequency carrier and a second cell on an inter-frequency carrier, wherein the measurement gap is shared for each measurement.

Example 22 may include the method of Example 21 or some other example herein, wherein the measurement gap is a per-Frequency Range 1 (FR1) measurement gap, wherein an FR1 is within an frequency range between 450 megahertz (MHz) and 6,000 MHz.

Example 23 may include the method of Example 22 or some other example herein, wherein the intra-frequency carrier is an FR1 intra-frequency carrier, and wherein the inter-frequency carrier is an FR1 inter-frequency carrier.

Example 24 may include the method of Example 21 or some other example herein, wherein the measurement gap is a per-Frequency Range 2 (FR2) measurement gap, wherein FR2 is within a frequency range between 24,250 MHz and 52,600 MHz.

Example 25 may include the method of Example 24 or some other example herein, wherein the intra-frequency carrier is an FR2 intra-frequency carrier, and wherein the inter-frequency carrier is an FR2 inter-frequency carrier.

Example 26 may include an apparatus to be implemented in a user equipment (UE), comprising: a means for storing configuration information to define a measurement gap; and a means for measuring, based on the measurement gap, a first cell on an intra-frequency carrier and a second cell on an inter-frequency carrier, wherein the measurement gap is shared for each measurement.

Example 27 may include the apparatus of Example 26 or some other example herein, wherein the measurement gap is a per-Frequency Range 1 (FR1) measurement gap, wherein an FR1 is within an frequency range between 450 megahertz (MHz) and 6,000 MHz.

Example 28 may include the apparatus of Example 27 or some other example herein, wherein the intra-frequency carrier is an FR1 intra-frequency carrier, and wherein the inter-frequency carrier is an FR1 inter-frequency carrier.

Example 29 may include the apparatus of Example 26 or some other example herein, wherein the measurement gap is a per-Frequency Range 2 (FR2) measurement gap, wherein FR2 is within a frequency range between 24,250 MHz and 52,600 MHz.

Example 30 may include the apparatus of Example 29 or some other example herein, wherein the intra-frequency carrier is an FR2 intra-frequency carrier, and wherein the inter-frequency carrier is an FR2 inter-frequency carrier.

Example 31 may include one or more non-transitory computer-readable media having instructions that, when executed by one or more processors, cause an apparatus of a user equipment (UE) to: store configuration information to define a measurement gap and to define an intra-frequency synchronization signal (SS)/physical broadcast channel (PBCH) block (SSB)-based measurement time configuration (SMTC) duration; and conduct, based on a measurement type and an overlap of the measurement gap and the SMTC duration, one or more measurement types.

Example 32 may include the one or more non-transitory computer-readable media of Example 31 or some other example herein, wherein the measurement type is an intra-frequency measurement without radio frequency (RF) tuning, and wherein the measurement gap overlaps at least in part with the SMTC duration.

Example 33 may include the one or more non-transitory computer-readable media of Example 32 or some other example herein, wherein the instructions, when executed by the one or more processors, further cause the apparatus to receive from a network an indication to disable the measurement gap to conduct the measurement type and disable, based on the indication to disable the measurement gap, the measurement gap to conduct the measurement type.

Example 34 may include the one or more non-transitory computer-readable media of Example 32 or some other example herein, wherein the instructions, when executed by the one or more processors, further cause the apparatus to use a portion of the SMTC duration outside of the measurement gap to conduct a measurement type.

Example 35 may include the one or more non-transitory computer-readable media of Example 31 or some other example herein, wherein the measurement type is an inter-frequency measurement, and wherein the measurement gap and the SMTC duration do not overlap.

Example 36 may include the one or more non-transitory computer-readable media of Example 32 or some other example herein, wherein the instructions, when executed by the one or more processors, further cause the apparatus to use a portion of the SMTC duration outside of the measurement gap to conduct a measurement type.

Example 37 may include the one or more non-transitory computer-readable media of Example 31 or some other example herein, wherein a first measurement type is an intra-frequency measurement with the measurement gap, and wherein a second measurement type is an inter-frequency measurement.

Example 38 may include the one or more non-transitory computer-readable media of Example 37 or some other example herein, wherein the measurement gap overlaps at least in part with the SMTC duration, wherein the instructions, when executed by the one or more processors, further cause the apparatus to use the measurement gap to conduct the first measurement type and the second measurement type, and wherein another measurement gap is disabled by a network.

Example 39 may include the one or more non-transitory computer-readable media of Example 38 or some other example herein, wherein a third measurement type is an intra-frequency measurement with an interruption, and wherein the instructions, when executed by the one or more processors, further cause the apparatus to use the measurement gap to conduct the third measurement type.

Example 40 may include the one or more non-transitory computer-readable media of Example 37 or some other example herein, wherein the measurement gap and the SMTC duration do not overlap, and wherein the instructions, when executed by the one or more processors, further cause the apparatus to use the measurement gap to conduct the first measurement type and the second measurement type.

Example 41 may include a method, comprising: storing configuration information to define a measurement gap and to define an intra-frequency synchronization signal (SS)/physical broadcast channel (PBCH) block (SSB)-based measurement time configuration (SMTC) duration; and conducting, based on a measurement type and an overlap of the measurement gap and the SMTC duration, one or more measurement types.

Example 42 may include the method of Example 41 or some other example herein, wherein the measurement type is an intra-frequency measurement without radio frequency (RF) tuning, and wherein the measurement gap overlaps at least in part with the SMTC duration.

Example 43 may include the method of Example 42 or some other example herein, further comprising receiving from a network an indication to disable the measurement gap to conduct the measurement type, and disabling, based on the indication to disable the measurement gap, the measurement gap to conduct the measurement type.

Example 44 may include the method of Example 42 or some other example herein, further comprising using a portion of the SMTC duration outside of the measurement gap to conduct a measurement type.

Example 45 may include the method of Example 41 or some other example herein, wherein the measurement type is an inter-frequency measurement, and wherein the measurement gap and the SMTC duration do not overlap.

Example 46 may include the method of Example 42 or some other example herein, further comprising using a portion of the SMTC duration outside of the measurement gap to conduct a measurement type.

Example 47 may include the method of Example 41 or some other example herein, wherein a first measurement type is an intra-frequency measurement with the measurement gap, and wherein a second measurement type is an inter-frequency measurement.

Example 48 may include the method of Example 47 or some other example herein, wherein the measurement gap overlaps at least in part with the SMTC duration, wherein the method further comprises using the measurement gap to conduct the first measurement type and the second measurement type, and wherein another measurement gap is disabled by a network.

Example 49 may include the method of Example 48 or some other example herein, wherein a third measurement type is an intra-frequency measurement with an interruption, and wherein the method further comprises using the measurement gap to conduct the third measurement type.

Example 50 may include the method of Example 47 or some other example herein, wherein the measurement gap and the SMTC duration do not overlap, and wherein the method further comprises using the measurement gap to conduct the first measurement type and the second measurement type.

Example 51 may include an apparatus to be implemented in a user equipment (UE), comprising: a means for storing configuration information to define a measurement gap and to define an intra-frequency synchronization signal (SS)/physical broadcast channel (PBCH) block (SSB)-based measurement time configuration (SMTC) duration; and a means for conducting, based on a measurement type and an overlap of the measurement gap and the SMTC duration, one or more measurement types.

Example 52 may include the apparatus of Example 51 or some other example herein, wherein the measurement type is an intra-frequency measurement without radio frequency (RF) tuning, and wherein the measurement gap overlaps at least in part with the SMTC duration.

Example 53 may include the apparatus of Example 52 or some other example herein, further comprising a means for receiving from a network an indication to disable the measurement gap to conduct the measurement type, and a means for disabling, based on the indication to disable the measurement gap, the measurement gap to conduct the measurement type.

Example 54 may include the apparatus of Example 52 or some other example herein, further comprising a means for using a portion of the SMTC duration outside of the measurement gap to conduct a measurement type.

Example 55 may include the apparatus of Example 51 or some other example herein, wherein the measurement type is an inter-frequency measurement, and wherein the measurement gap and the SMTC duration do not overlap.

Example 56 may include the apparatus of Example 52 or some other example herein, further comprising a means for using a portion of the SMTC duration outside of the measurement gap to conduct a measurement type.

Example 57 may include the apparatus of Example 51 or some other example herein, wherein a first measurement type is an intra-frequency measurement with the measurement gap, and wherein a second measurement type is an inter-frequency measurement.

Example 58 may include the apparatus of Example 57 or some other example herein, wherein the measurement gap overlaps at least in part with the SMTC duration, wherein the apparatus further comprises a means for using the measurement gap to conduct the first measurement type and the second measurement type, and wherein another measurement gap is disabled by a network.

Example 59 may include the apparatus of Example 58 or some other example herein, wherein a third measurement type is an intra-frequency measurement with an interruption, and wherein the apparatus further comprises a means for using the measurement gap to conduct the third measurement type.

Example 60 may include the apparatus of Example 57 or some other example herein, wherein the measurement gap and the SMTC duration do not overlap, and wherein the apparatus further comprises a means for using the measurement gap to conduct the first measurement type and the second measurement type.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

1.-20. (canceled)

21. An apparatus to be implemented in a user equipment (UE), the apparatus comprising:
memory, to store configuration information to define a measurement gap; and
processing circuitry, coupled with the memory, to:
conduct, during the measurement gap, measurements on a first cell on an intra-frequency carrier and a second cell on an inter-frequency carrier, wherein the measurement gap is shared for each measurement.

22. The apparatus of claim 21, wherein the measurement gap is a per-Frequency Range 1 (FR1) measurement gap.

23. The apparatus of claim 22, wherein the intra-frequency carrier is an FR1 intra-frequency carrier, and wherein the inter-frequency carrier is an FR1 inter-frequency carrier.

24. The apparatus of claim 21, wherein the measurement gap is a per-Frequency Range 2 (FR2) measurement gap.

25. The apparatus of claim 24, wherein the intra-frequency carrier is an FR2 intra-frequency carrier, and wherein the inter-frequency carrier is an FR2 inter-frequency carrier.

26. An apparatus to be implemented in a user equipment (UE), the apparatus comprising:
means for storing configuration information to define a measurement gap; and
means for measuring, based on the measurement gap, a first cell on an intra-frequency carrier and a second cell on an inter-frequency carrier, wherein the measurement gap is shared for each measurement.

27. The apparatus of claim 26, wherein the measurement gap is a per-Frequency Range 1 (FR1) measurement gap.

28. The apparatus of claim 27, wherein the intra-frequency carrier is an FR1 intra-frequency carrier, and wherein the inter-frequency carrier is an FR1 inter-frequency carrier.

29. The apparatus of claim 26, wherein the measurement gap is a per-Frequency Range 2 (FR2) measurement gap.

30. The apparatus of claim 29, wherein the intra-frequency carrier is an FR2 intra-frequency carrier, and wherein the inter-frequency carrier is an FR2 inter-frequency carrier.

31. One or more non-transitory computer-readable media having instructions that, when executed by one or more processors, cause an apparatus of a user equipment (UE) to:
store configuration information to define a measurement gap; and
conduct, during the measurement gap, measurements on a first cell on an intra-frequency carrier and a second cell on an inter-frequency carrier, wherein the measurement gap is shared for each measurement.

32. The one or more non-transitory computer-readable media of claim 31, wherein the measurement gap is a per-Frequency Range 1 (FR1) measurement gap.

33. The one or more non-transitory computer-readable media of claim 32, wherein the intra-frequency carrier is an FR1 intra-frequency carrier, and wherein the inter-frequency carrier is an FR1 inter-frequency carrier.

34. The one or more non-transitory computer-readable media of claim 31, wherein the measurement gap is a per-Frequency Range 2 (FR2) measurement gap.

35. The one or more non-transitory computer-readable media of claim 34, wherein the intra-frequency carrier is an FR2 intra-frequency carrier, and wherein the inter-frequency carrier is an FR2 inter-frequency carrier.

36. An apparatus to be implemented in a user equipment (UE), the apparatus comprising:
means for receiving configuration information that defines a measurement gap; and
means for conducting, during the measurement gap, measurements on a first cell on an intra-frequency carrier and a second cell on an inter-frequency carrier, wherein the measurement gap is shared for each measurement.

37. The apparatus of claim 36, wherein the measurement gap is a per-Frequency Range 1 (FR1) measurement gap.

38. The apparatus of claim 37, wherein the intra-frequency carrier is an FR1 intra-frequency carrier, and wherein the inter-frequency carrier is an FR1 inter-frequency carrier.

39. The apparatus of claim 36, wherein the measurement gap is a per-Frequency Range 2 (FR2) measurement gap.

40. The apparatus of claim 39, wherein the intra-frequency carrier is an FR2 intra-frequency carrier, and wherein the inter-frequency carrier is an FR2 inter-frequency carrier.
